(19) United States
(12) Patent Application Publication
(10) Pub. No.: US 2021/0013616 A1
(43) Pub. Date: Jan. 14, 2021

(54) ANTENNA DEVICE AND MANUFACTURING METHOD OF MANHOLE COVER

(71) Applicant: Hitachi, Ltd., Tokyo (JP)

(72) Inventors: Masami OONISHI, Tokyo (JP); Kenichi MIZUGAKI, Tokyo (JP); Rintaro KATAYAMA, Tokyo (JP); Ryosuke FUJIWARA, Tokyo (JP)

(21) Appl. No.: 16/908,906

(22) Filed: Jun. 23, 2020

(30) Foreign Application Priority Data
Jul. 10, 2019 (JP) 2019-128746

(51) Int. Cl. H01Q 13/12; H01Q 13/18; H01Q 1/38; E02D 29/14

(52) U.S. Cl. CPC H01Q 13/12; H01Q 13/18; H01Q 1/38; E02D 2250/003; E02D 2250/0007; E02D 2250/0023; E02D 29/14

(57) ABSTRACT

An antenna device includes a conductive manhole cover for partitioning an internal space of a manhole and an external space, a wireless device installed in the internal space, and a base station that is installed in the external space and transfers a radio wave with respect to the wireless device. When a notch portion is formed on the edge of the manhole cover and the manhole cover is attached to an opening of the manhole, a slot-shaped void is formed. By using this void as a slot antenna, radio waves from the wireless device can be re-emitted to the external space. With such a configuration, it is not necessary to specially prepare a slot antenna, and a low-cost antenna device can be realized.

### CROSS-REFERENCE TO RELATED APPLICATION

The present application claims priority from Japanese application JP 2019-128746, filed on Jul. 10, 2019, the contents of which is hereby incorporated by reference into this application.

### BACKGROUND OF THE INVENTION

### 1. Field of the Invention

The present invention relates to an antenna device and a manufacturing method of a manhole cover used for the antenna device.

### 2. Description of the Related Art

Many infrastructure facilities such as water supply, sewer, electricity, gas, and telephone are buried and installed underground. Infrastructure facilities buried underground generally have many manholes for maintenance and inspection. Maintenance and inspection work is indispensable for the stable and normal functioning of such infrastructure facilities. However, since the number of manholes is very large and work is required in a narrow space, manual maintenance and inspection work is difficult and requires heavy labor. Further, since a vehicle, a person, or the like passes over the cover for closing the hole of the manhole, there is a problem that the maintenance and inspection work cannot be freely performed at any time.

In consideration of such circumstances, there is employed a maintenance management system in which a sensor is provided to detect information (data) necessary for maintenance and inspection of facilities in the manhole, and the data detected by this sensor is sequentially transmitted to a server in the center that performs maintenance management by wireless devices. Therefore, the burden of maintenance and inspection work by an operator monitoring these data and performing maintenance and inspection is reduced.

By the way, in such a system, it is necessary to reliably transmit the radio wave emitted from the antenna of the wireless device installed in the manhole to the base station installed in the external space, and to transmit it to the server via the base station. However, a metal cover (hereinafter referred to as a manhole cover) is provided on the upper portion of the manhole. Therefore, there is a problem that the radio wave of the wireless device installed in the manhole is absorbed and attenuated by the manhole cover, and it becomes difficult to reach the base station installed in the external space. In that case, in order to ensure that the radio waves reach the base station, a high-power wireless device with a high radio wave intensity (power) may be installed. However, such a wireless device is expensive, and it is not realistic to install the high-power and expensive wireless devices for a large number of manholes. In addition, since such a wireless device consumes a large amount of battery power, it cannot be used stably for a long period of time, and it is necessary to frequently replace the battery.

Therefore, conventionally, there has been known a technique of an antenna device studied so as to reduce radio wave attenuation by the manhole cover and surely transmit the radio wave of the wireless device in the manhole to an external base station. For example, in Japanese Patent Publication Laid-Open No. 2004-7210, there is disclosed a technique in which a slot antenna is installed on the inner surface side of a keyhole of the manhole cover (the back surface of the manhole cover), and the radio waves emitted by the antenna are emitted from the keyhole to the external space. Further, in JP 2004-7210 A, there is disclosed a technique of a slot antenna in which a slot is formed in a metal material having a U-shaped cross section and an L-shaped main body at the edge of the cover of a rectangular handhole (small manhole).

### SUMMARY OF THE INVENTION

By the way, in the configuration in JP 2004-7210 A in which the slot antenna is attached to the back side of the manhole cover, it is estimated that the keyhole is small and radio waves are not sufficiently emitted from the keyhole. Further, although the slot antenna is attached to the back side of the keyhole by a magnet, there is a possibility that the installation position of the slot antenna may be shifted due to vibration of a passing vehicle or an earthquake. Further, wiring for supplying power to the slot antenna is also required.

Further, in the configuration of JP 2004-7210 A in which the slot antenna is installed at the edge of the rectangular handhole, in order to install the antenna in the handhole cover, a slot antenna using a metal member having a complicated shape of the slot antenna is necessarily prepared, and the manufacturing cost becomes high. Further, since the manhole is a metal member having a complicated shape, there are various sizes and shapes of the manhole, so it is difficult to properly insert and install the antenna having a complicated shape.

As described above, in all of the techniques disclosed in JP 2004-7210 A, the slot antenna is installed on the manhole cover, and it is necessary to prepare the slot antenna. Therefore, the cost of the entire antenna device increases.

Therefore, an object of the invention is to provide a low-cost antenna device that has a simple structure but reduces attenuation of radio waves emitted from a wireless device, and a method of manufacturing a manhole cover used for the antenna device.

In order to solve the above problems, the invention is, for example, an antenna device in which at least one notch portion having a predetermined length is formed in an edge of the antenna device as a slot antenna. The antenna device includes a structure that forms an internal space, a cover or a door for partitioning an external space of the structure, a wireless device that is installed in the internal space, and a base station that is installed in the external space and transfers a radio wave with respect to the wireless device. At least one notch portion having a predetermined length is formed at an edge of the cover or the door, and a void formed by attaching the cover or the door to the structure is used as a slot antenna.

According to the invention, since the slot antenna can be formed only by forming a notch portion provide in an edge of a cover or a door, it is possible to provide an antenna device which is very simple and has low radio wave attenuation and is low in cost.

### BRIEF DESCRIPTION OF THE DRAWINGS

FIG. 1 is a perspective view of a main part of an antenna device according to a first embodiment of the invention;

FIG. 2 is a top view of the first embodiment illustrated in FIG. 1;

FIG. 3 is a cross-sectional view illustrating a cross section taken along line A-A′ of the first embodiment illustrated in FIG. 1;

FIG. 4 is a diagram for explaining the operation principle of the first embodiment illustrated in FIG. 1;

FIG. 5 is a diagram illustrating an example of a cross section of a notch portion in the embodiment of the invention;

FIG. 6 is a diagram illustrating another example of the cross section of the notch portion in the embodiment of the invention;

FIG. 7 is a diagram illustrating another example of the cross section of the notch portion in the embodiment of the invention;

FIG. 8 is a diagram illustrating an example of the shape of the notch portion in the embodiment of the invention;

FIG. 9 is a perspective view of a main part of the antenna device according to a second embodiment of the invention; and

FIG. 10 is a perspective view of a main part of the antenna device according to a third embodiment of the invention.

### DESCRIPTION OF THE PREFERRED EMBODIMENTS

Hereinafter, specific embodiments in which the invention is applied to a manhole will be described with reference to the drawings. The invention is not limited to the embodiments described below. Further, in each drawing, common or similar components are designated by the same reference numerals, and duplicate description thereof may be omitted.

### First Embodiment

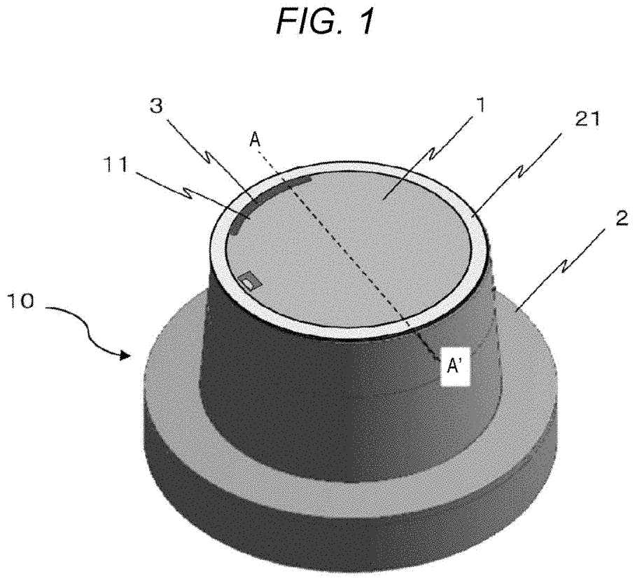

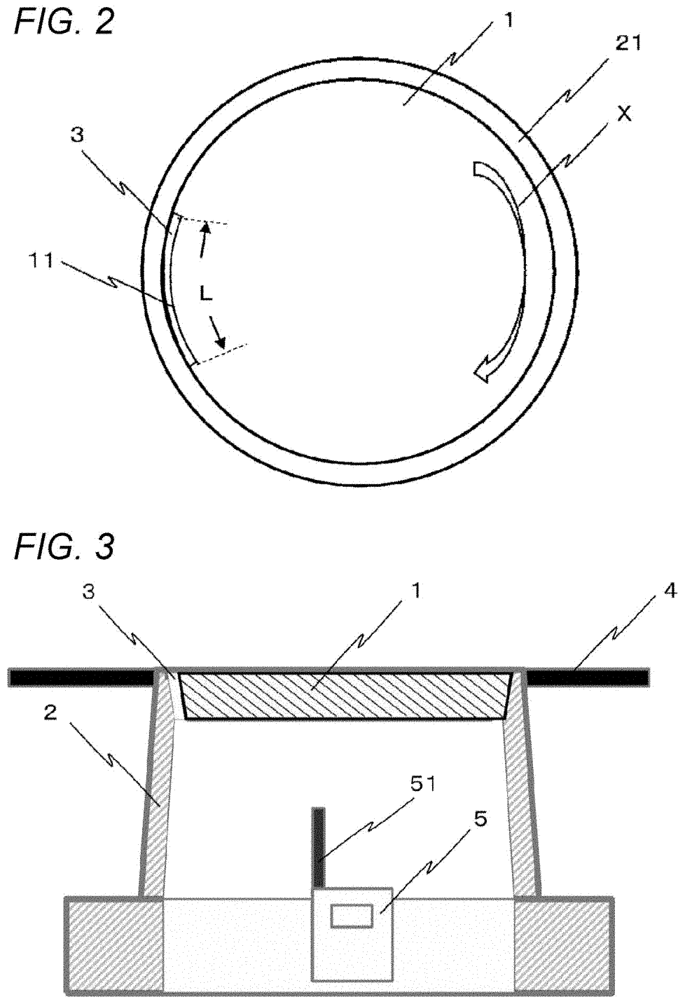

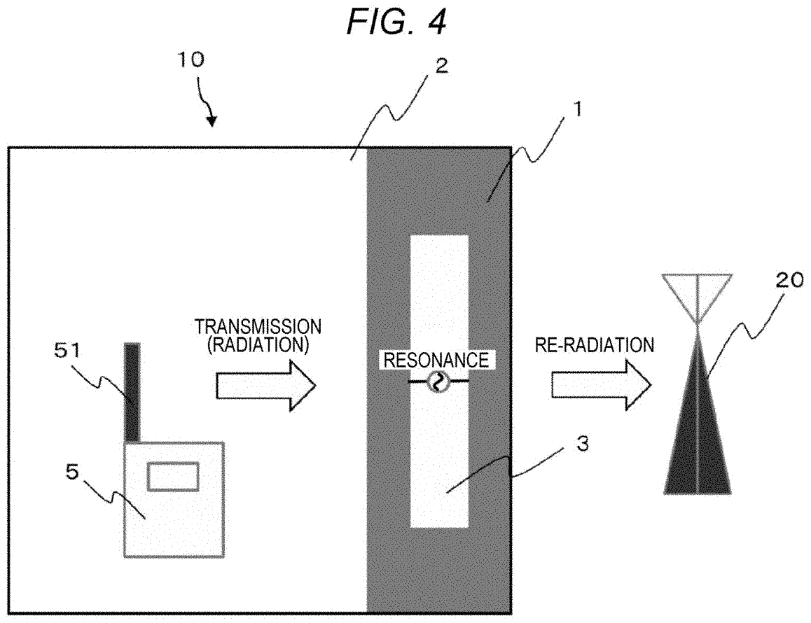

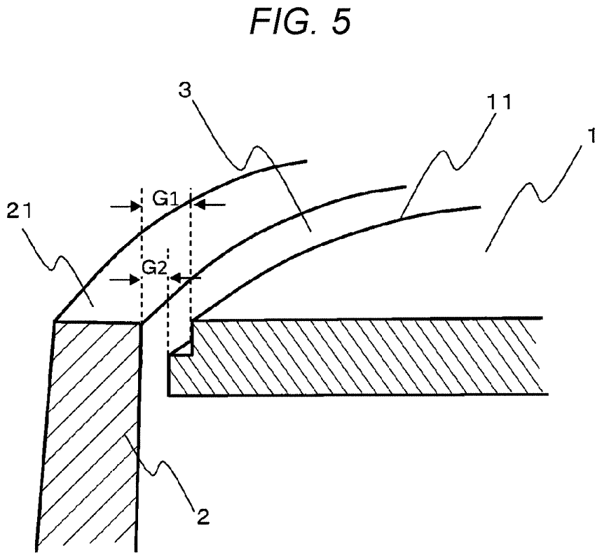

A first embodiment of the invention will be described using FIGS. 1 to 8. FIG. 1 is a perspective view of a main part of an antenna device according to the first embodiment of the invention. FIG. 2 is a top view of the first embodiment illustrated in FIG. 1 when viewed from above. FIG. 3 is a cross-sectional view illustrating a cross section taken along line A-A′ of the first embodiment illustrated in FIG. 1. FIG. 4 is a diagram for explaining the operation principle of the first embodiment illustrated in FIG. 1. FIGS. 5 to 8 illustrate examples of the shape of the notch portion of the manhole cover.

### Explanation of Antenna Device of First Embodiment

First, an antenna device according to the first embodiment of the invention will be described with reference to FIGS. 1 to 4. In FIG. 1, a manhole 10 is configured by a manhole main body 2 (hereinafter, referred to as a main body) buried in the ground, and a manhole cover 1 for covering (closing) an opening of the main body 2 on the ground surface side. Further, in these drawings, a keyhole used for attaching (fitting) or removing the manhole cover 1 with respect to the opening 21 of the main body 2 and for fixing the cover is omitted.

In FIGS. 1 to 3, the manhole cover 1 has a notch portion 11 formed at a part of its edge. When the manhole cover 1 having the notch portion 11 is fitted (attached) into the opening 21 of the main body 2, a slot-shaped void 3 is formed between the inside of the opening 21 of the main body 2 and the notch portion 11 of the manhole cover 1. The length L (see FIG. 2) of the slot-shaped void 3 is set to a predetermined length capable of exciting the radio wave of a wireless device. In this example, the length L of the notch portion 11 is set to be approximately half the wavelength λ of the radio wave radiated from an antenna 51 of the wireless device 5 illustrated in FIG. 3, and the void 3 configured by the opening 21 and the notch portion 11 functions as a slot antenna. That is, the notch portion 11 is formed in the manhole cover 1 and the manhole cover 1 is attached to form the slot antenna having the void 3, and the slot antenna functions as a relay antenna for emitting the radio wave inside the manhole to the outside.

### Explanation of Functional Principle of First Embodiment

Next, the functional principle of the slot antenna (the void 3) in the first embodiment will be described using FIG. 4. In FIG. 4, a wireless device 5 installed inside the manhole 10 radiates a radio wave including detection data of a sensor (not illustrated) from the antenna 51. This radio wave resonates in the slot antenna formed so that the length of the void 3 is L=λ/2, and is re-radiated to the external space. In this way, the slot antenna functions as a relay antenna, so that there is almost no attenuation of radio waves by the manhole cover 1. The re-radiated radio wave is received by an external base station 20 and transmitted via the base station 20 to a server (not illustrated). As described above, by having the slot antenna in which the length of the edge portion of the void 3 is λ/2, it is possible to increase the reach distance of the radio wave by the wireless device 5, so that the wireless device 5 reliably reaches the base station 20.

### Adjustment of Radiation Direction by Manhole Cover

FIG. 2 is a diagram of the first embodiment of FIG. 1 viewed from above. The slot-shaped void 3 in FIG. 2 is formed between the main body 2 and the manhole cover 1. Here, the arrow X illustrated in the clockwise direction indicates that the manhole cover 1 is rotatable. When mounting (placing) the manhole cover 1 on the main body 2, the manhole cover 1 is mounted while being rotated appropriately in the X direction so that radio waves can easily reach the base station. Of course, it may be rotated counterclockwise. Specifically, the manhole cover 1 is adjusted toward the base station 20 so as to emit a strong radio wave. By performing such adjustment, the radio wave can surely reach the base station. In this case, in this embodiment, not only the slot antenna can be easily formed, but also the azimuth of radio wave emission can be adjusted only by rotating the manhole cover 1. Further, FIG. 3 is a cross-sectional view taken along line A-A′ of FIG. 1, and illustrates that the wireless device is disposed inside the manhole and the void 3 is formed at the edge portion of the manhole cover 1. Various sensors for detecting the internal condition are omitted here.

### Length of Notch Portion of Manhole Cover

As described above, the predetermined length L of the notch portion 11 of the manhole cover is basically L=λ/2, where λ is the wavelength of the radio wave used. This is because when the length is L=λ/2, the radio wave is excited and can be emitted most efficiently. By the way, it is known that this length L is different in exciting frequency by filling the void 3 formed by the notch portion 11 with a resin which is a dielectric. Therefore, in the first embodiment, when the resin is filled, the length L needs to be adjusted to a predetermined length. That is, when the resin is filled, the length L is set to a predetermined length which is shortened in accordance with the dielectric constant or the like of the resin when the resin is not filled. By filling the slit-shaped void 3 with resin, the length L of the notch portion 11 formed in the manhole cover 1 can be shortened, and the strength of the manhole cover 1 becomes stronger accordingly. Further, by filling the resin, it is possible to prevent rainwater, dust, and the like from flowing into the manhole, and it is useful for protecting the internal wireless device, sensor, and the like.

### Shape of Void of Slot Antenna

Next, the width of the void 3 will be described. In the embodiment of FIG. 1, the width of the void 3 formed by the notch portion 11 at the edge of the manhole cover is the same in the thickness direction of the manhole cover (up and down direction in the drawing), and this width G is within a range of 1 to 10 mm. Then, the width of the void is made equal in the thickness direction of the manhole cover 1.

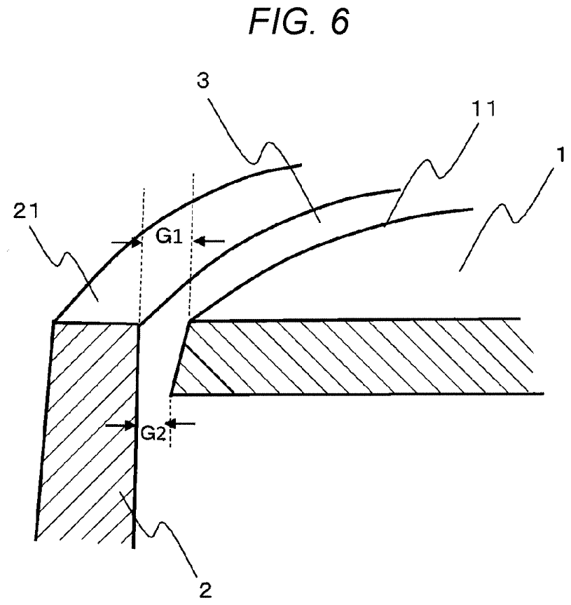

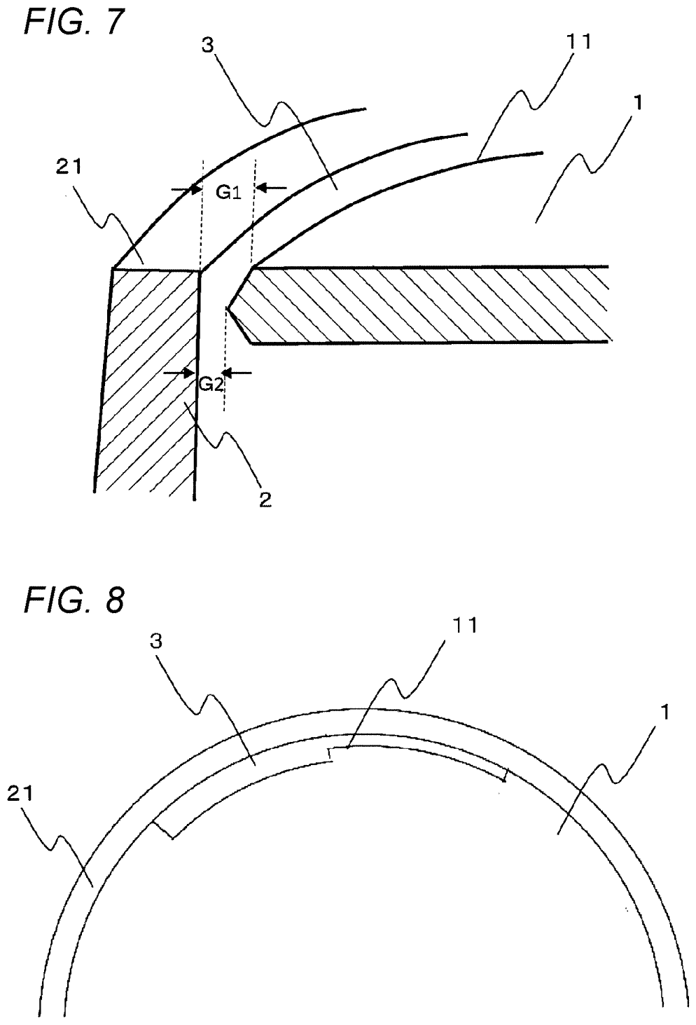

Here, if the width G is configured to be different in the thickness direction of the manhole cover 1, impedance adjustment for widening the band in the slot antenna can be performed. As a result, it is possible to make an efficient slot antenna. An example in which the width of the void is changed in the thickness direction of the manhole cover 1 is illustrated in FIGS. 5 to 7. FIG. 5 illustrates a configuration in which a width G1 is changed to a width G2 in the middle of the manhole cover 1 in the thickness direction. Further, FIG. 6 illustrates an example in which the manhole cover 1 is tapered from G1 to G2 in the thickness direction. FIG. 7 illustrates an example in which G1 is changed to G2 and G2 is changed to G1 in the thickness direction of the manhole cover 1. The impedance can be easily adjusted by adjusting the degree of the width change. Further, in FIG. 8, the shape of the void 3 is changed in the middle, instead of making the shape of the notch portion 11 of the edge in the length direction constant. Even with such a configuration, impedance adjustment can be facilitated in order to widen the band as in FIGS. 5 to 7.

### Manufacturing Method of Manhole Cover

Next, a method of forming the notch portion 11 of the manhole cover 1 in the first embodiment will be described. In the invention, it is necessary to form the notch portion 11 having a predetermined length at the edge of the manhole cover 1. In this case, the notch portion 11 can also be formed by cutting or the like, but cast iron is often used as the material of the manhole cover, and the cast iron is hard to process, so it is difficult to form a uniform notch portion 11. It cannot be said that it is a good method of manufacturing a large number of manhole covers.

Therefore, the manhole cover having the notch portion 11 according to the first embodiment allows the notch portion to be formed at the casting stage. That is, when the manhole cover 1 is cast into a mold, a mold capable of forming the notch portion 11 having a predetermined length is prepared, and molten metal is poured into the mold to cast the manhole cover 1. As a result, the manhole cover 1 having the notch portion 11 of a predetermined length can be automatically formed. The method of manufacturing the manhole cover used in the invention by such a manufacturing method is preferable because the manufacturing is simple and the homogeneous manhole cover can be mass-produced. If it is difficult to accurately form the length of the notch portion 11 only by casting with a mold, cutting, polishing, or the like is performed after taking out from the mold as needed. Further, in order to change the width in the thickness direction as illustrated in FIGS. 5 to 7 described above, the mold may be formed with an inclined or stepped notch portion in the thickness direction of the manhole cover of the notch portion.

### Effect of First Embodiment

As described above, in the first embodiment of the invention, the notch portion is formed in a part of the manhole cover, and the slot antenna can be formed by attaching this manhole cover, and it is possible for the slot antenna to release the radio wave to the external space. As a result, the reach distance of radio waves can be increased. In the device of the first embodiment, it is not necessary to prepare a slot antenna and install the antenna, and since the slot antenna can be configured only by installing (attaching) the manhole cover, a simple and low-cost antenna device can be realized. There are a large number of manholes installed, and there are many types (various sizes and shapes). Therefore, the merit of being able to realize a slot antenna simply by forming a notch portion in the manhole cover is extremely advantageous. In addition, by rotating the manhole cover when attaching it, the azimuth (directivity) of radio wave emission can be adjusted so that the radio wave can easily reach an external base station. Further, by filling the void 3 with resin, the length of the notch portion of the manhole cover can be shortened.

### Second Embodiment

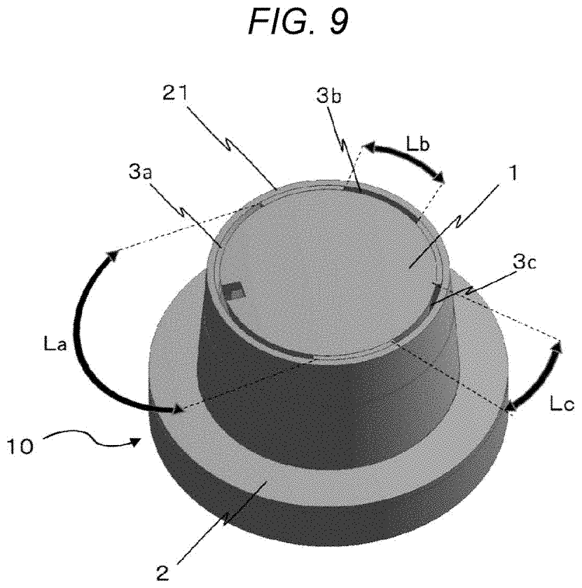

Next, a second embodiment of the invention will be described using FIG. 9. FIG. 9 is a perspective view illustrating the outline of the antenna device according to the second embodiment of the invention. The second embodiment has basically the same configuration as the above-described first embodiment, but is different in that the manhole cover 1 in the second embodiment has a plurality of notch portions, and a plurality of slot antennas are formed by the main body 2 side and the void formed by the notch portion of the manhole cover 1. Therefore, the difference will be mainly described here, and the other description will be omitted.

In FIG. 9, the manhole cover 1 is formed with three notch portions (reference numerals are omitted) having lengths La, Lb, and Lc. When the manhole cover 1 is attached to the opening 21 of the main body 2, three slit-shaped voids 3a, 3b, and 3c having lengths La, Lb, and Lc are formed. As a result, three slit antennas are formed. A wireless device (not illustrated) is installed inside the manhole 10 and emits radio waves of a plurality (three types in this example) of wavelengths. If those wavelengths are λa, λb, and λc, and if the slot antennas with the voids having La, Lb, and Lc each are selected to be excited by those wavelengths λa, λb, and λc, the radio waves having the frequencies of three bands are emitted to the external space through the respective slot antennas without being attenuated by the manhole cover 1.

Also in the second embodiment, the length of the notch portion formed in the manhole cover 1 can be shortened by filling the void with resin, which is a dielectric. Further, by using a dielectric, it is possible to prevent rainwater and dust from flowing into the manhole. It is also effective for fixing the manhole cover 1. In this example, the manhole cover is provided with three notch portions, but it may be two or four or more. Further, in the manufacture of the manhole cover in this embodiment, as described in the first embodiment, a mold capable of forming the plurality of notch portions is prepared, and molten metal is injected into the mold. The length of the notch portion is a predetermined length that resonates with the radio waves of the wireless device as a slot antenna.

As described above, according to the second embodiment, not only the effect of the first embodiment is obtained, but also the length of each slot antenna formed by the notch portion of the manhole cover is set to a value adapted to a desired frequency. As a result, it can be used in a plurality of frequency bands.

### Third Embodiment

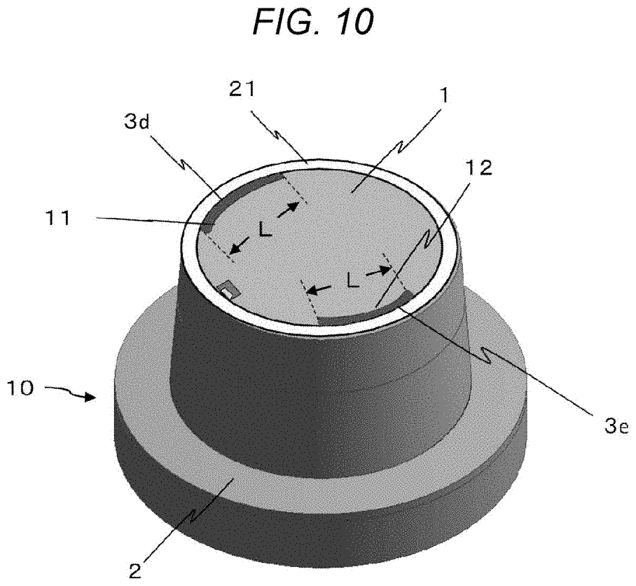

Next, a third embodiment of the invention will be described using FIG. 10. FIG. 10 is a perspective view illustrating the outline of the antenna device according to the third embodiment of the invention. The third embodiment has basically the same configuration as the above-described first embodiment, but is different in that the manhole cover 1 in the third embodiment has two notch portions, and two voids (slot antennas) are formed which are formed by the main body 2 side and the notch portion of the manhole cover 1. Therefore, the difference will be mainly described here, and the other description will be omitted.

In FIG. 10, the manhole cover 1 is formed with two notch portions 11 and 12. In this embodiment, the notch portions 11 and 12 have the same length L. When the manhole cover 1 is attached to the opening 21 of the main body 2, two voids 3d and 3e having the length L are formed and a slot antenna is formed. The lengths L of the voids 3d and 3e forming the slot antenna are selected so as to resonate with the wavelength λ of the radio wave emitted by the internal wireless device 5 (not illustrated). With such a configuration according to the third embodiment, the directivity directions of the slot antennas can be made different, and it is possible to cover any direction. For example, in the configuration illustrated in FIG. 10, by rotating the manhole cover 1 so as to emit a strong radio wave toward the base station 20 (not illustrated), the directivity direction of the radio wave radiated from the slot antenna can be changed to the base station. Therefore, it is possible to reliably perform transmission.

Although the lengths L of the two slot antennas formed by the slot-shaped voids 3d and 3e are the same in the third embodiment of FIG. 10, they may be different as in the case of the second embodiment. In that case, two frequencies can be radiated from the slot antenna, and the directivity directions of the slot antenna can be made different. Also in this second embodiment, the length of the notch portion formed in the manhole cover 1 can be shortened by filling the voids 3d and 3e with a dielectric (resin). Further, by using a dielectric, it is possible to prevent rainwater and dust from flowing into the manhole. It is also effective when fixing the manhole cover 1.

As described above, according to the third embodiment, in addition to the effect as in the above-described first embodiment, the directivity direction of each slot antenna can be made different, and it is possible to cover any direction.

### Other Embodiments

The invention is not limited to the above-described embodiments of the invention, and various modifications are included within the scope of the technical idea of the invention. That is, the invention is not limited to an antenna device for performing data transmission in a manhole, but may be widely applied to an antenna device which includes a conductive cover or door for partitioning an internal space and an external space, a wireless device installed in the internal space, and a base station that is installed in the external space and that transmits and receives radio waves to and from the wireless device.

What is claimed is:

1. An antenna device, comprising:
a structure that forms an internal space;
a cover or a door for partitioning an external space of the structure;
a wireless device that is installed in the internal space; and
a base station that is installed in the external space and transfers a radio wave with respect to the wireless device,
wherein at least one notch portion having a predetermined length is formed at an edge of the cover or the door, and a void formed by attaching the cover or the door to the structure is used as a slot antenna.

2. The antenna device according to claim 1, wherein a plurality of the notch portions are provided.

3. The antenna device according to claim 2, wherein the plurality of the notch portions have the same length.

4. The antenna device according to claim 2, wherein the plurality of the notch portions have different lengths, and when the wireless device emits the radio waves of a plurality of frequencies, the lengths of the plurality of the notch portions are predetermined lengths capable of resonating with the plurality of frequencies respectively.

5. The antenna device according to claim 1, wherein the notch portion is filled with a dielectric.

6. The antenna device according to claim 1, wherein the notch portion is formed such that a width of the void differs in a thickness direction of the cover or the door.

7. The antenna device according to claim 1, wherein the notch portion is formed such that a width of the void differs in a length direction of the notch portion.

8. The antenna device according to claim 1, wherein the structure is a manhole and the cover is a manhole cover.

9. A method of manufacturing a manhole cover to be attached to a manhole, comprising:
preparing a mold in which a notch portion of a predetermined length for forming a slot antenna is formed when the manhole cover is attached to the manhole; and
casting the manhole cover by injecting molten metal into the mold.

10. The method of manufacturing the manhole cover according to claim 9, wherein the mold is configured to manufacture the manhole cover having a plurality of the notch portions.

11. The method of manufacturing the manhole cover according to claim 9, wherein the mold is configured to be inclined or stepped in a thickness direction of the manhole cover of the notch portion.
